(19) United States
(12) Patent Application Publication
(10) Pub. No.: US 2011/0026768 A1
(43) Pub. Date: Feb. 3, 2011

(54) Tracking a Spatial Target

(76) Inventors: Sujai Chari, Burlingame, CA (US); Sanjay Mani, Los Altos Hills, CA (US); Thomas Kurian, Livermore, CA (US)

Correspondence Address: Law Office of Brian Short, P.O. Box 641867, San Jose, CA, 95164-1867, US

(21) Appl. No.: 12/843,988

(22) Filed: Jul. 27, 2010

Related U.S. Application Data
(60) Provisional application No. 61/271,905, filed on Jul. 28, 2009.

(51) Int. Cl. G06K 9/00

(52) U.S. Cl. 382/103

(57) ABSTRACT

Apparatuses and methods for tracking a dermatological feature are disclosed. One method includes establishing an imaging reference proximate to an identified dermatological feature, wherein the imaging reference has a known color spectrum and known physical dimensions. A digital image sequence is obtained containing one or more images of the identified dermatological feature and the imaging reference. At least one trait of the identified dermatological feature is estimated using the imaging reference and at least one image of the digital image sequence.

### RELATED APPLICATIONS

This patent application claims priority to U.S. provisional patent application Ser. No. 61/271,905 filed on Jul. 28, 2009 which is incorporated by reference.

### FIELD OF THE EMBODIMENTS

The described embodiments relate generally to image monitoring. More particularly, the described embodiments relate to tracking a spatial target, such as, a dermatological feature.

### BACKGROUND

There are many applications which contain objects or targets that are evolving over time. The aspects of the targets that are evolving and the rate of change vary considerably as a function of the target. Monitoring the evolution pattern of the targets can help understand the cause of the evolution, predict the future evolution, evaluate the impact of a treatment on a target, and also can lead to decisions such as taking corrective measures to alter the evolution and/or possibly replacing/removing the target at a chosen point in time.

Examples of the utility of such a system range over a wide variety of applications in which a spatial target evolves over time. These include health care, surveying, agriculture and other fields. Specifically, a spatial target tracking system could be used to monitor growth of human skin lesions as well as a dermatologist could be provided with periodic reports of observed changes. The evolution of other dermatological conditions such as acne or wrinkles could be monitored, as could the impact of a single corrective measure or a series of corrective measures over time. The evolution of wounds could also be monitored using a spatial target tracking system. The evolution of vegetation could be monitored. The evolution of hair density could be monitored.

It is desirable to have a method and apparatus for monitoring spatial targets, such as a dermatological feature.

### SUMMARY

An embodiment includes a method for tracking a dermatological feature. The method includes establishing an imaging reference proximate to an identified dermatological feature, wherein the imaging reference has a known color spectrum and known physical dimensions. A digital image sequence is obtained containing one or more images of the identified dermatological feature and the imaging reference. At least one trait of the identified dermatological feature is estimated using the imaging reference and at least one image of the digital image sequence.

The method can additionally include analyzing the digital image sequence to determine that the at least one trait of the identified dermatological feature can be estimated with the imaging reference with fidelity greater than a threshold. For an embodiment, the step of estimating the at least one trait of the identified dermatological feature using the imaging reference and at least one image of the digital image sequence is executed if the fidelity is greater than the threshold. The at least one image of the digital image sequence can then be registered.

Another embodiment includes a computing device. The computing device includes a controller and electronic memory operable to receive a downloadable dermatological tracking program. When the dermatological tracking program has been downloaded, the controller is operable to cause the computing device to perform the following steps: obtain a digital image sequence containing one or more images of an identified dermatological feature and an imaging reference and establish the imaging reference proximate to the identified dermatological feature in the digital image sequence, wherein the imaging reference has a known color spectrum and known physical dimensions. At least one trait of the identified dermatological feature is estimated using the imaging reference and at least one image of the digital image sequence.

Another embodiment is to use a constant spatial reference, and use this reference to estimate at least one trait of an identified dermatological feature.

Another embodiment includes applying a scale independent feature detection algorithm to least one image of the digital image sequence in order to generate a first bitmap containing one or a plurality of identified dermatological feature or features, and also generate a second bitmap of pixels which do not contain one or a plurality of identified dermatological feature or features. These bitmaps are used to characterize evolution over the series of digital image sequences of a trait or a plurality of traits of the one or a plurality of identified dermatological feature or features.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an example of a spatial target imaging device that is located proximate to a spatial target for obtaining images of the spatial target.

FIG. 2 shows a block diagram of a spatial target imaging device.

FIG. 3 shows an example of a spatial target at several different points in time.

FIG. 4 shows a spatial target along with an image reference at several points in time, and a block diagram of a spatial target tracking system that tracks a spatial target and an imaging reference.

FIG. 5 is a flow chart showing one example of a method of tracking a spatial target.

FIG. 6 is a flow chart that includes steps of another example of a method for tracking a spatial target.

FIG. 7 is a flow chart showing another example of a method of tracking a spatial target.

### DETAILED DESCRIPTION

The described embodiments include methods and apparatuses for tracking one or more spatial targets. An exemplary spatial target is a dermatological feature located on, for example, a human user. An exemplary dermatological feature can include a lesion or a wrinkle in the human user's skin.

A spatial target is an object or an area of interest which is placed in the field of view of an imaging device. One method of monitoring the evolution of the spatial target is through the use of imaging. One device that can be used to obtain the images is the digital camera. There is a need for a system that can effectively and accurately monitor the evolution pattern of a spatial target and report observed changes with sufficient resolution/accuracy. There is also a need for a system to monitor the evolution pattern for a chosen set of features of the spatial target.

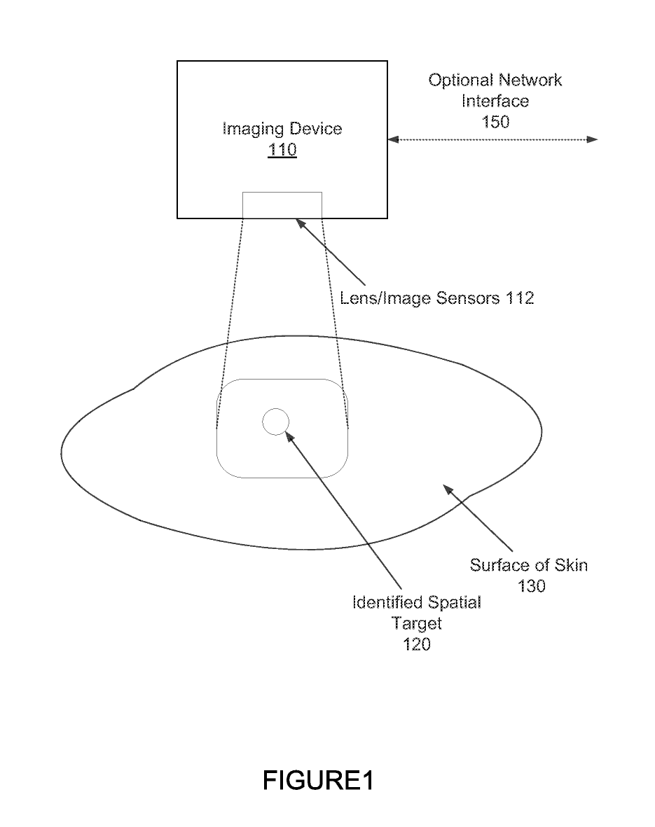

FIG. 1 shows an example of a spatial target imaging device 110 that is located proximate to a spatial target for obtaining images of a spatial target 120. As mentioned, examples of spatial targets include lesions and/or wrinkles in a user's skin 130. The spatial target imaging device 110 obtains images of the spatial target. By comparing images of the spatial target over time, changes in the spatial target can be observed. The changes can be useful for identifying, for example, growth or changes in a lesion over time. The changes can be useful for identifying the evolution of wrinkles, or for determining the effectiveness of remedies that are intended to reduce wrinkles.

Difficulties in analysis can result if the images obtained do not meet some level of image quality. Therefore, certain procedures can be followed in the acquisition of the images. Image processing can then be used to reduce the effects of image impairments. As will be described, references can be placed proximate to the spatial target to aid in the processing of images of the spatial target.

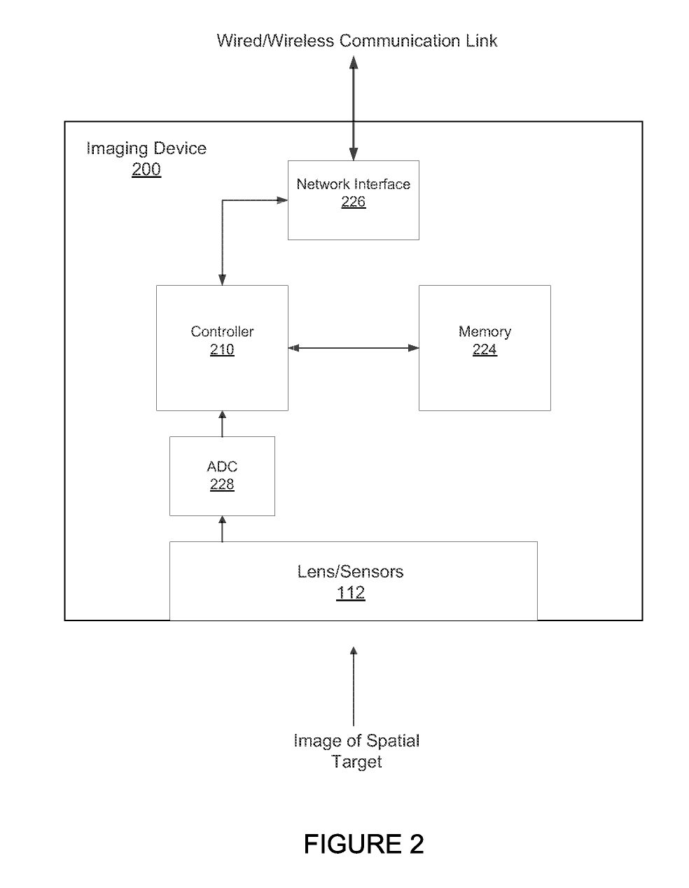

FIG. 2 shows a block diagram of a spatial target imaging device 200. An embodiment of the spatial imaging device (which can be referred to more generally as a computing device) includes a controller 210 and electronic memory 220. Examples of spatial target imaging devices include a digital camera, a camera in a cell phone, camcorder, or a custom imaging device.

In operation, the spatial target imaging device 200 performs the following steps. First, the spatial target imaging device 200 obtains a digital image sequence containing one or more images of an identified dermatological feature, and an imaging reference, wherein the imaging reference has a known color spectrum and known physical dimensions. Second, at least one trait of the identified dermatological feature is estimated using the imaging reference and at least one image of the digital image sequence. Useful traits to estimate include physical dimensions, depth or area of the feature. The trait estimation can have multiple values, such as a series of lengths or depths corresponding to the feature.

The embodiment shown in FIG. 2 includes a lens/sensors 112 and an analog to digital converter (ADC) 228 that converts the analog image signals to digital image signals which can then be processed. The digital images can be stored in the memory 224. The controller 210 can store and access the digital images for processing and comparison of the images. A network interface 226 can download programs and/or data, and upload alerts and/or data to a remote server.

According to one embodiment, the controller 210 is operable as controlled by a downloadable dermatological tracking program. That is, the spatial target imaging device 200 can receive downloadable dermatological tracking programs that can be targeted, for example, for different specific applications of dermatological tracking and/or monitoring.

For the purposes of discussion of the described embodiments, a sequence includes a sequence of images (or single image) acquired corresponding to a particular point in time. As will be described, a digital image sequence with corresponding time stamps is obtained during a time interval less than a first threshold, wherein an identified dermatological feature evolves in time greater than a second threshold, and wherein the first threshold is less than the second threshold. A series includes a series of sequences corresponding to the history of a spatial target location that is stored in a database. A new sequence includes a newly acquired sequence that can be validated, calibrated, and then possibly added to a database.

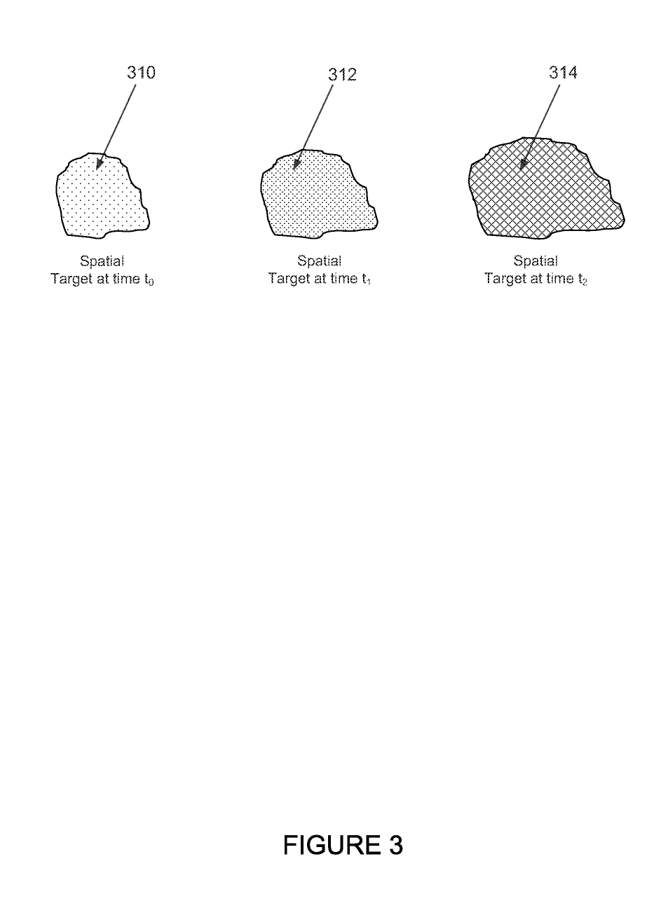

FIG. 3 shows a spatial target at a first point in time (t₀) 312, a second point in time (t₁) 314, and third point in time (t₂) 316. As shown, the spatial target changes (evolves) over time. Detection of changes, and detection of the types of changes of the spatial target can be used to identify problems and/or issues about the spatial target, or evaluate a corrective action or series of corrective actions on the spatial target

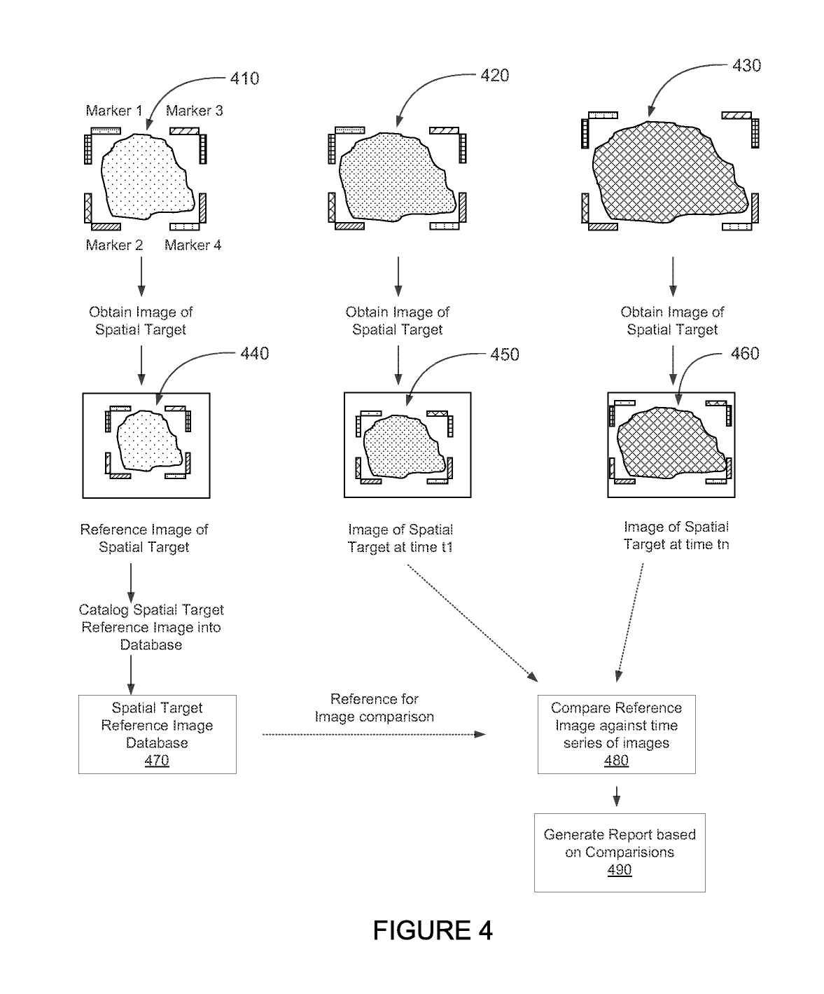

FIG. 4 shows a spatial target along with an image reference at several points in time, and a block diagram of a spatial target tracking system that tracks a spatial target and an imaging reference. The spatial target and imaging reference (Marker 1, Marker 2, Marker 3, Marker 4) are shown at three separate points in time 410, 420, 430. Below each of the spatial target and imaging reference depiction are corresponding images 440, 450, 460 obtained by an imaging device. The first image 440 can be stored and cataloged within a database as a spatial target reference image (470). The subsequent images 450, 460 can subsequently be stored and cataloged within the database. The subsequent images 450, 460 can be compared with the reference image 440 (480). A report can then be generated based on the comparisons (490). A later image (420, 430) can later replace the first image 410 as a reference, or alternately a reference image can be synthesized out of multiple digital images of the series.

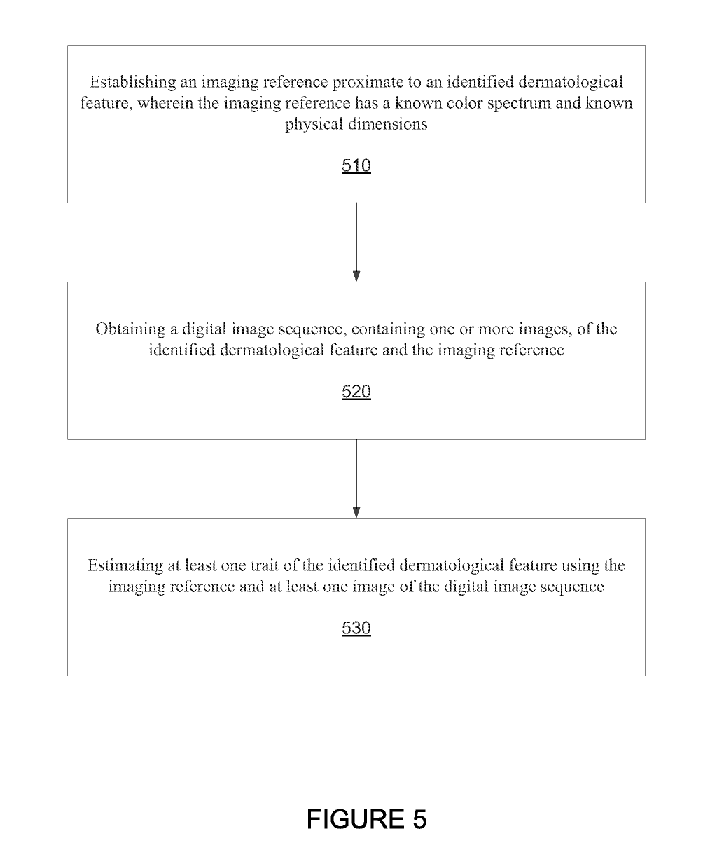

FIG. 5 is a flow chart that includes steps of an example of a method of tracking a dermatological feature. A first step 510 includes establishing an imaging reference proximate to an identified dermatological feature, wherein the imaging reference has a known color spectrum and known physical dimensions. A second step 520 includes obtaining a digital image sequence, containing one or more images, of the identified dermatological feature and the imaging reference. A third step 530 includes estimating at least one trait of the identified dermatological feature using the imaging reference and at least one image of the digital image sequence.

The trait estimation enables assessment of the evolution of the spatial target. For example, the spatial target can be wrinkle(s), and the trait(s) can be area covered by wrinkle(s) and/or the wrinkle(s) depth. The tracking can be employed to assess a wrinkle treatment, by using it to evaluate if wrinkle area and depth are increasing, decreasing, or not evolving noticeably over time. Another application is to assess when a treatment should be applied, due to a trend in the evolution of a trait of a spatial target that exceeds a threshold.

The digital image sequences can be stored on a central server, wherein the server is remotely accessible. Further, for an embodiment, obtaining a digital image sequence includes image acquisition and processing software determining if obtained images for the identified dermatological feature have been previously registered.

An embodiment includes prompting a user to reinitiate obtaining a digital image sequence of the identified dermatological feature, wherein the prompting is based on an amount of time since last obtaining of a digital image sequence.

If the identified dermatological feature is a lesion, the color spectral distribution of the imaging reference can be chosen based on the color spectral distribution of skin on which lesion is present. A change report can be electronically sent, for example, to a dermatologist or insurance company, to document the evolution of the spatial target, enabling treatment and insurance processes.

The estimation step 530 can be conditionally executed. More specifically, the digital image sequence can be analyzed to determine that the at least one trait of the identified dermatological feature can be estimated with the imaging reference with fidelity greater than a threshold. An embodiment includes executing the estimation step 530 if the fidelity is greater than the threshold. The at least one image of the digital image sequence can then be registered.

Embodiments of estimating at least one trait of the identified dermatological feature using the imaging reference includes at least one of a geometric area, geometric size, geometric depth, geometric length, geometric volume, spectral color, or spectral intensity. For an embodiment, the identified dermatological feature represents a spatial region where features being estimated within the spatial region comprise multiple spatial elements.

An embodiment includes obtaining the digital image sequence with corresponding time stamps during a time interval less than a first threshold, wherein identified dermatological feature evolves in time greater than a second threshold, and wherein the first threshold is less than the second threshold. At least one of a series of the digital image sequences is acquired, wherein a second time interval between acquisitions of each digital image sequence of each series is greater than the second threshold. The at least one of a series of digital image sequences are organized along with corresponding time stamps by assembling the series in a catalog, wherein each series represents time evolution of at least one trait of the identified dermatological feature or a plurality of dermatological features.

The image acquisition points in time denoted as t0, t1, etc. are chosen in order for the images to show evolution in the spatial target. The target may or may not evolve to a degree detectable by the trait estimation procedure during the separation between the points in time, depending on its rate of change and the accuracy/resolution of the trait estimation as implemented. The time points can also be chosen in response to a treatment event or events, after which the efficacy of the treatment could be evaluated.

An additional embodiment includes analyzing a series of digital image sequences, wherein the analyzing comprises characterizing evolution over the series of digital image sequences of an estimated trait or plurality of traits of a dermatological feature or plurality of dermatological features. For an embodiment, characterizing evolution over the series of digital image sequences of an estimated trait or plurality of traits of a dermatological feature or plurality of dermatological features includes applying a scale independent feature detection algorithm to at least one image of at least one sequence of the series of digital image sequences to produce a first output image. The first output image represents the dermatological features detected by the algorithm, for example, ridges or valleys or edges.

A first series of image morphology operations are applied to the first output image to produce a second output image. This second image represents a refinement of the features detected in the first image to heighten the sensitivity to the desired dermatological feature detection, for example enhancement of wrinkles. A first bit map representing pixels containing the dermatological feature or plurality of dermatological features is generated based on the second output image. A second series of image morphology operations and/or algorithmic steps is performed on the first image to produce a third output image. Based on the third output image, a second bit map is generated representing pixels not containing the dermatological feature or plurality of dermatological features. This second series of operations may include a subset of the operations used to generate the first bitmap. By way of illustration, the pixels located at positions on the first bitmap where the values are 1 can correspond to positions that are expected to contain the dermatological feature to be analyzed. The pixels located at positions on the second bitmap where the values are 1 correspond to positions that are expected to not contain the dermatological feature to be analyzed. Note that due to the finite accuracy and probabilistic nature of detection algorithms, the second bitmap is unlikely to simply be the inverse of the first bitmap, but to be some subset of pixels in the inverse of the first bitmap, to increase the probability that these pixels do not contain dermatological features to be analyzed. The first and second bit-maps are combined with one or a plurality of the images of the series of digital image sequences to create a first set of feature containing pixels and second set of non-feature containing pixels. Evolution over the series of digital image sequences of an estimated trait or plurality of traits using the first and second set of pixels is characterized. The first bitmap can be applied in each image of the series to extract feature containing pixels for application of a first estimation algorithm, and the second bitmap can be applied to each image of the series for application of a background or imaging reference second estimation algorithm for normalization or correction of the output of the first algorithm.

A further embodiment includes geometrically aligning the images of the series so that the location of the pixels is aligned with the image used to create the first and second bitmaps. This alignment can be done in several ways, for example, aligning the features in the image series that are constant through the series acquisition, or at least between two sequential sequence acquisitions. This alignment allows the bitmaps to be properly applied to the series of digital image sequences so that the correct dermatological feature and non-dermatological feature pixels are extracted for estimation.

Embodiments include comparatively analyzing the digital image sequence with at least one previously acquired digital image sequence to identify relative differences. More specifically, these embodiments can include calibrating geometric or spectral traits using the imaging reference in the digital image sequence and a previously stored series of image sequences, and determining if calibration is required beyond a first threshold. The calibrated image sequence is correlated with the previously stored series of image sequences, and it is determined if correlation is required beyond a second threshold, and then images are selected from the digital image sequence for which calibration required is less than the first threshold and correlation is greater than the second threshold. The first calibration threshold can be selected, for example, by determining with the imaging reference how much magnification is required for analysis of the digital image sequence, and if the amount required is below a first threshold, the image is selected for further analysis. The second correlation threshold can be selected, for example, by determining the degree of overlap between the imaged area between the two sequences and if it is above a threshold, the image is selected for further analysis.

For an embodiment, establishing an imaging reference includes placing markers adjacent to, inside, and/or around a circumference of the identified dermatological feature, wherein the markers comprise known spatial parameters. The number of markers used can be selected based at least in part on a previously obtained digital image sequence. A color of the markers can be selected based on a background color of the identified dermatological feature. A reflectivity of the markers can be selected based on color spectrum of a flash of an image capturing device.

An embodiment of the markers includes at least one of rulers, 2D rectangles or circles, or 3D cubes or cylinders with an adhesive on at least one edge or surface. For embodiments, the markers include structures providing a resolution of the identified dermatological feature of at least a first threshold, and a color calibration of at least a second threshold. In order to estimate a spatial target above a threshold of resolution, the imaging reference must typically have greater than this resolution, or at a minimum this same threshold of resolution. For example, if the imaging target should be estimated to 1 mm resolution, the imaging reference should have calibration marks or be of a size with accuracy known <=1 mm, typically 0.1 mm. In order to estimate a spatial target above a threshold of accuracy for a color calibration, the imaging reference must have a color calibration of a higher or equal degree of accuracy. For example, if the imaging target's redness or red component should be estimated to an accuracy of 4 bits, where 0000 represents no intensity of the red component and 1111 represents the maximum possible intensity of the red component, then the imaging reference should have red markers with a resolution of at least 4 bits or 16 shades of intensity of the red component ranging from no intensity to maximum intensity. The accuracy of each shade to a known reference color calibration distribution should also be known to at least 4 bits, and ideally more than 4 bits. For another embodiment, the marker is an ink or other drawn, printed or stamped marker on the surface encompassing the dermatological feature.

An embodiment includes analyzing the digital image sequence to determine that the at least one trait of the identified dermatological feature can be estimated with an image impairment better than a threshold. The step of estimating the at least one trait of the identified dermatological feature using the imaging reference and at least one image of the digital image sequence is executed if the image impairment is better than the threshold. The digital image sequence is then registered. Examples of image impairments include blurring of target (due to motion or failed focus), suboptimal field of view or location of image device relative to spatial image, low fraction of target captured, suboptimal lighting, suboptimal camera angle, excessive glare, and poor SNR.

An embodiment includes determining if a quality of at least one image of the digital image sequence is less than the threshold, and providing corrective measures for recapturing the at least one image of the digital image sequence of the dermatological feature and the imaging reference based on analysis of components of the quality of the at least one image of the digital image sequence. Further, the threshold can be dynamically adjusted based on at least one of characteristics of identified dermatological feature and previously acquired digital image sequences.

For an embodiment registering the digital image sequence along with time stamps includes adding the digital image sequence to a series, wherein the series contains a plurality of previously acquired and stored digital image sequences representing a same identified dermatological feature, or if no series exists, starting a new series using this digital image sequence as a base sequence. The digital image sequence and one or a plurality of stored series are analyzed to match the digital image sequence based on an imaged dermatological feature into a existing series representing this imaged dermatological feature. User classification of the digital image sequence is corrected if there is an insufficient match of dermatological feature to series to which user assigned sequence.

Registration

Embodiments include image acquisition/processing software being used to determine where previous images of the spatial target have been registered. Alternatively, user input can be used to specify whether series of images of the spatial target have been registered. If no previous series of images of the spatial target have been obtained, an embodiment includes user input being solicited to obtain a name/ID, along with date, time as part of the registration process. Alternatively, the date/time can be automatically obtained from the imaging device.

Markers

An embodiment includes establishing an imaging reference by placing markers (ruler/stickers) adjacent to, around circumference of, or inside spatial target, wherein the markers include known spatial parameters. For instance, the markers may contain evenly spaced markings separated by a distance, αₓ, α_{y}, α_{z} on the x, y, z axes respectively where the desired resolution on detection of relative size change in the spatial target are thresholds, βₓ, β_{y}, β_{z} on the x, y, z axes respectively where αₓ<βₓ, α_{y}<β_{y}, α_{z}<β_{z}.

In addition to markings that provide size resolution, markings could be provided in a variety of colors with sufficient resolution to facilitate color calibration. The specific colors chosen for the markers could be dependent on the color characteristics of the spatial target as well as the background around the spatial target. The imaging reference could also be a known size or diameter. The imaging reference can also have a feature size greater than the desired target resolution estimation.

The number of markers to be used for the imaging reference can be selected based at least in part on previously obtained series of images of the spatial target (if available). The shapes of the markers may also be selected based on knowledge of the spatial target which can be obtained from previous images of the spatial target. Some examples of shapes that could be used for the markers are shown in FIG. 4. Note that the markers can be 2D or 3D cubes, cylinders or circles/spheres. An embodiment includes an adhesive used on an edge or surface to prevent movement of the markers during image capture. Additionally, the color or color gradient of the markers can be selected based a background color of the spatial target.

The reflectivity of the markers could be selected based on color spectrum of a flash or light source of an image capturing device. Color spectrum of flash or light source could be measured or known a priori. Based on the spectrum, a lookup table could be created that lists a recommended marker reflectivity or color for a image capturing device.

Alternatively, a smart flash could be used to adjust the lighting. Smart flash could sense the current ambient lighting present prior to a session using a light sensor, and then calculate the deviation from necessary optimal lighting with flash and switches on one or multiple LEDs in the LED flash array to provide optimum lighting during the session.

Image Selection

The new sequence of digital image(s) including the spatial target and markers can be analyzed to determine that a quality of at least a subset of the new sequence of digital image(s) is greater than a threshold. Qualities include at least one of an image focus or blur (due to motion or failed focus), location of image device relative to spatial image (i.e. suboptimal field of view), fraction of image captured, adequate of use of markers, degree of lighting, camera angle, degree of glare, SNR, or degree of feature discrimination. The determination of the quality can include determining if image focus is greater than required threshold. The determination of the quality can include determining if camera lens distance to spatial target meets required criteria for sufficient feature extraction. The determination of the quality can include determining whether fraction of spatial target captured allows for sufficient feature extraction. The determination of the quality can include determining whether number of markers used allows for sufficient feature extraction or their placement was correct. The determination of the quality can include determining if image was captured with proper lighting or correct light spectrum or correct camera angle. The determination of the quality can include determining if image should be recaptured with a different angle of capture. The determination of the quality can include determining whether resolution at edges of spatial target exceeded a threshold and requesting user to take subsequent images if resolution falls below the threshold. The determination of the quality can include determining whether there is sufficient SNR or C(Contrast)NR in image. The determination of the quality can include determining whether there is sufficient feature resolution on reference in image. The determination of the quality can include determining whether the glare allows for sufficient feature extraction

If the quality of an image is less than the threshold, an embodiment includes image analysis software providing corrective measures for the recapturing of a new sequence of images of the spatial target and marker based on analysis of components of quality of image.

Additionally, the image analysis software may further dynamically adjust the threshold or thresholds based on at least one of characteristics of spatial target and previously acquired and stored series of digital images.

Image Analysis

Following the selection of images with sufficient quality, an embodiment of the image analysis software can estimate at least one feature of the spatial target using the imaging reference. Exemplary estimated features include, for example, geometric properties such as shape, border, asymmetry, fractal dimension, size, depth, area, volume, density; spectral properties such as color, grayscale, reflectivity; statistical properties of distribution of digital image pixels comprising spatial target such as intensity; geometric mapping or projection of spatial target; estimation of parameters of spatial target. Additionally, color and geometric calibration can be performed using markers. Note that a spatial target can be a target region where one of the above features are determined, for example, the density of hair in a region.

Following the estimation of spatial target feature(s) from the selected image(s), the image analysis software can comparatively analyze the newly acquired sequence of digital image(s) with at least one previously cataloged digital image to validate that the new sequence can be analyzed with a previous sequence and to perform additional calibration as needed to the new sequence based on information from the previous sequence. Color and geometric calibration on new sequence can be performed using information from previous series (automatic registration algorithm). A ‘matching’ threshold can be calculated on new sequence using information from previous series. If calibration is required beyond the threshold, then guidance can be provided on required image reacquisition including lighting, angle, and/or suggest distance between lens and object and request recollection. Images with sufficient correlation can be selected from new sequence using series of reference image(s) from previously stored series of images. If at least a subset of new sequence of images have a correlation with the reference images from the series of images then proceed to analysis phase, else determine cause of poor correlation. It can be determined if incorrect reference/registered series of images are being used for comparison. If so, a request/suggest correct series of reference/registered image(s) can be performed.

Following the comparison with previously cataloged images, if sufficient matching or correlation is observed, then image analysis software may search for evolution across series of images of spatial target. This can include determining trending or growth or variation of spatial target, and/or determining changes in color. Data/findings from latest collection can be summarized. Qualitative and/or quantitative trending can be determined in estimated features across time series of images. Observed change(s) can be reported.

Recording Results

Following the analysis of the spatial target in the digital image(s) for changes from cataloged images, an embodiment of image recording software can catalog the calibrated digital image along with a time stamp. Specifically, the cataloging may include adding a digital image to sequence of one or more of previously acquired and stored digital images representing same spatial target, or if no series exists, starting a new series with this first image representing the reference registered image. Additional data can optionally be linked to digital image such as date/time from camera acquisition field. Functions including a ‘recognize’ or ‘auto-sort’ of the spatial target can be optionally based on surrounding digital markers to appropriate spatial target based on currently stored spatial target images. User classification of new spatial target can optionally be corrected based on insufficient match to baseline (optionally part of ‘matching threshold’). The cataloging can optionally tag based on current information in auto-storage site.

After the digital image(s) have been cataloged, an embodiment of the image reporting software includes prompting a user to reinitiate tracking of the spatial target, wherein the prompting is based on an amount of time since last tracking.

Lesion Monitoring

An example of a spatial target is a skin lesion. Skin lesions can be monitored using a spatial target tracking imaging system. Once a specific lesion has been identified as a target, initial reference images could be obtained which include markers placed proximate to the target lesion and the image(s) captured should include the markers as well as the target lesion. The marker characteristics can be chosen based on the characteristics of the lesion. For instance, the colors on the markers can be chosen based on the color of the target lesion as well as the overall skin color. Specifically, the colors can be chosen to improve the color calibration of the skin and lesion colors to allow maximum contrast which will enhance lesion border detection and improve accuracy of growth determination based on future collection of target lesion images.

After sufficient high quality images have been obtained of the target lesion, at least a subset of the new sequence of images is stored representing the registered reference sequence of images for the target lesion.

The user can be reminded of the recommended next image collection date to facilitate subsequent monitoring of the target lesion.

When subsequent image sequences of the target lesion along with the markers are collected at later points in time, the images which have quality higher than a SNR/contrast threshold and/or correlation with the previously registered images higher than a correlation threshold will be used to detect change patterns in the target lesion. Observed changes including trending across the series of images will be reported. Optionally, a report encompassing the observed changes may be sent to a dermatologist to document which could be used for enabling treatment and insurance process.

Lesion Imaging Impairments

Several impairments can reduce the quality of images collected for monitoring skin lesions. The presence of hairs in the image is an example of one such impairment. Hairs can often obscure the borders of lesions which can reduce the accuracy of growth of lesions where hairs are present around the borders of the target lesions. Some possible approaches to overcome this issue include explicit detection and estimation of hairs and focusing on lesion growth on portions of lesion where hairs are not obscuring the border. Images can be obtained from different angles where hairs do not obscure the lesion borders as much from certain angles. Time series of images can be used to aid in detection and estimation of hair growth to improve collection of process that minimizes the image degradation due to the presence of hairs.

The skin can also stretch or compress across the time series of images based on the amount of pressure being applied to the area where the target lesion resides. Consequently, significant and varying distortion can result across images of the target lesion. Proper design of three dimensional markers will be required to facilitate sufficient calibration/compensation for the distortion in order to evaluate the time series of images for possible growth of the target lesion. Additionally, the angle of the camera relative to the target lesion may need to be chosen judiciously to minimize the impact of skin shape distortion.

Other imaging impairments are related to changes in image projection angle. These impairments can be geometrically corrected. Other impairments could be due to changes in physical acquisition parameters such as lighting spectrum, range, or acquisition with a different camera. These can be corrected with reference.

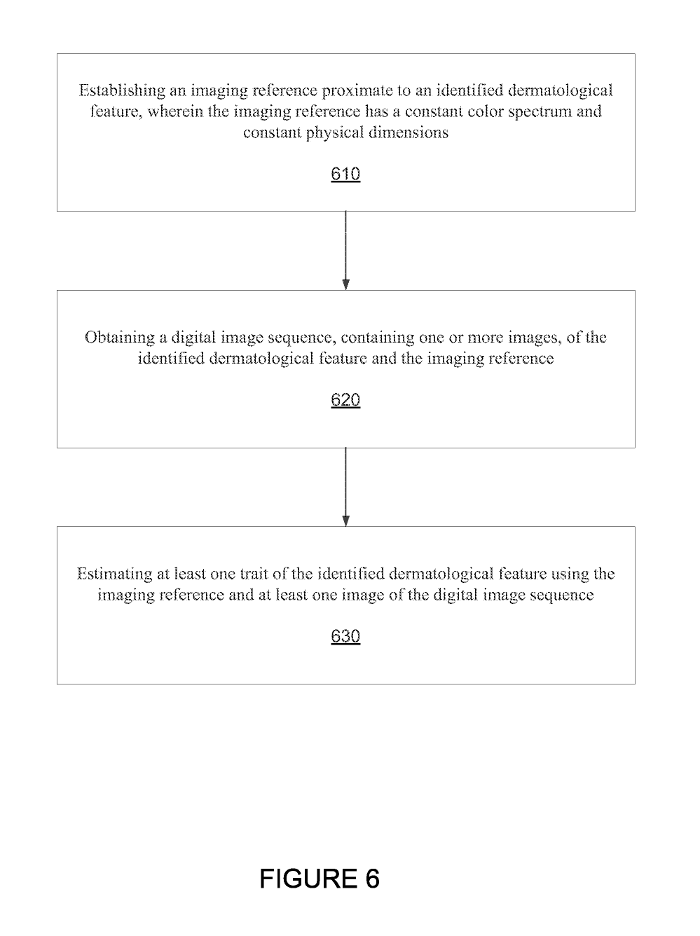

FIG. 6 is a flow chart that includes steps of another example of a method for tracking a spatial target. The method of FIG. 6 is very similar to the method of FIG. 5, but includes the imaging reference having a constant color spectrum and constant physical dimensions rather than a known color spectrum and known physical dimensions. The constant imaging reference has properties used to estimate a trait of the spatial target, such as optical spectral properties or spatial properties that do not change on the time scale of acquiring either a digital image sequence or a series of digital image sequences. So for example this can be a non-contiguous set of background pixels in an image identified as not including the dermatological feature. It can be a different non-varying dermatological feature. A first step 610 includes establishing an imaging reference proximate to an identified dermatological feature, wherein the imaging reference has a constant color spectrum and constant physical dimensions. A second step 620 includes obtaining a digital image sequence, containing one or more images, of the identified dermatological feature and the imaging reference. A third step 630 includes estimating at least one trait of the identified dermatological feature using the imaging reference and at least one image of the digital image sequence.

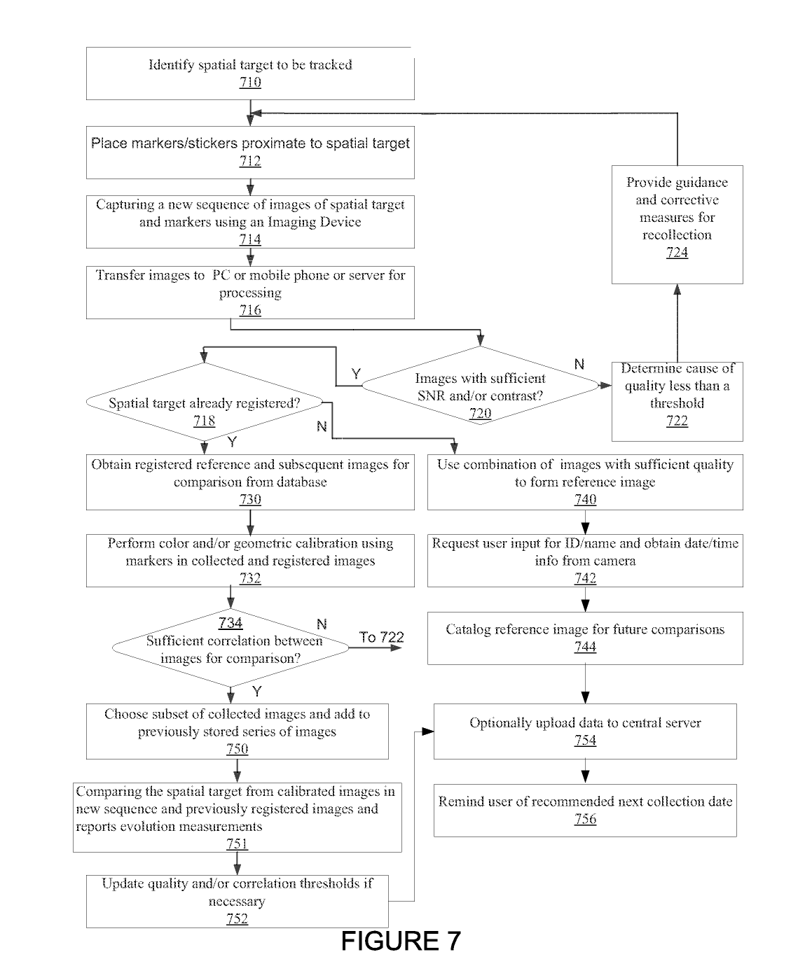

FIG. 7 is a flow chart showing another example of a method of tracking a spatial target. A step 710 includes identification of a spatial target to be tracked. A step 712 includes placing markers/stickers proximate to the identified spatial target. A step 714 includes capturing a new sequence of images of spatial target and markers (i.e. imaging reference) using an Imaging Device. A step 716 includes transferring the new sequence of images to a PC or mobile phone for further processing. A step 720 checks if images have sufficient SNR and/or contrast to be registered and used as a reference. If the images do not have sufficient SNR and/or contrast, the next step 722 determines possible causes of quality less than a threshold. The following step 724 provides guidance and corrective measures to user before user recollects images.

If the images have sufficient SNR, the next, a step 718 checks if images of the spatial target have been previously registered. If images of the spatial target have not been registered the next step 740 includes using a combination of images with sufficient SNR and/or contrast to form a reference image of the identified spatial target. The next step 742 includes requesting user input for ID/name and obtain date/time info from camera. The following step 744 includes cataloging the reference image for future comparison. It is to be understood that for this step, cataloging includes registering the reference image to the identified spatial target. The following step 754 includes optionally uploading images and measurements to a central server. The following step 756 reminds user of a recommended next collection date for images of the identified spatial target.

If the check from the fifth step 718 determines that images of the spatial target have been registered, a sixth step 730 obtains the registered reference and subsequent images in the series (if present) for comparison from database. A seventh step 732 includes performing color and/or geometric calibration using markers in images from the new sequence and registered images of the spatial target. A subsequent check 734 includes determining whether there is sufficient correlation between a subset of images in new sequence and previously registered images. If there is insufficient correlation, the tracking procedure proceeds to step 722 for determining possible causes for quality less than a threshold.

If there is sufficient correlation, a next step 750 includes choosing a subset of images from a new sequence to add to previously stored series of images of the spatial target. This includes registering the chosen subset of images to the identified spatial target. The following step 751 includes comparing the spatial target from calibrated images in new sequence and previously registered images and reports evolution measurements. The subsequent step 752 includes updating quality and/or correlation thresholds based on calibration, correlation and evolution measurement results. The next step 754 includes optionally uploading images and measurements to a central server. The following step 756 reminds user of a recommended next collection date for images of the identified spatial target.

Although specific embodiments have been described and illustrated, the described embodiments are not to be limited to the specific forms or arrangements of parts so described and illustrated. The embodiments are limited only by the appended claims.

1. A method for tracking a dermatological feature, comprising:
establishing an imaging reference proximate to an identified dermatological feature, wherein the imaging reference has a known color spectrum and known physical dimensions;
obtaining a digital image sequence, containing one or more images, of the identified dermatological feature and the imaging reference;
estimating at least one trait of the identified dermatological feature using the imaging reference and at least one image of the digital image sequence.

2. The method of claim 1, further comprising:
analyzing the digital image sequence to determine that the at least one trait of the identified dermatological feature can be estimated with the imaging reference with fidelity greater than a threshold;
wherein the step of estimating the at least one trait of the identified dermatological feature using the imaging reference and at least one image of the digital image sequence is executed if the fidelity is greater than the threshold; and
registering the at least one image of the digital image sequence.

3. The method of claim 1, further comprising
obtaining the digital image sequence with corresponding time stamps during a time interval less than a first threshold, wherein identified dermatological feature evolves in time greater than a second threshold, and wherein the first threshold is less than the second threshold;
acquiring at least one of a series of the digital image sequences, wherein a second time interval between acquisition of each digital image sequence of each series is greater than the second threshold;
organizing the at least one of a series of digital image sequences along with corresponding time stamps by assembling the series in a catalog, wherein each series represents time evolution of at least one trait of the identified dermatological feature or a plurality of dermatological features.

4. The method of claim 1, further comprising:
comparatively analyzing the digital image sequence with at least one previously acquired digital image sequence to identify relative differences.

5. The method of claim 1, wherein establishing an imaging reference comprises at least one of placing markers adjacent to, inside, or around a circumference of the identified dermatological feature, wherein the markers comprise known spatial parameters.

6. The method of claim 5, wherein a number of markers is selected based at least in part on a previously obtained digital image sequence.

7. The method of claim 5, wherein a color of the markers is selected based on a background color of the identified dermatological feature.

8. The method of claim 5, wherein a reflectivity of the markers is selected based on color spectrum of a flash of an image capturing device.

9. The method of claim 5, wherein the markers comprise at least one of rulers, 2D rectangles or circles, or 3D cubes or cylinders with an adhesive on at least one edge or surface.

10. The method of claim 5, wherein the markers comprise structures providing a resolution of the identified dermatological feature of at least a first threshold, and a color calibration of at least a second threshold.

11. The method of claim 1, wherein obtaining a digital image sequence comprises an image capturing device obtaining a set of digital images where the image capturing device comprises at least one of a cell phone, digital camera, camcorder, or a custom digital imaging device.

12. The method of claim 1, wherein obtaining a digital image sequence comprises image acquisition and processing software determining if obtained images for the identified dermatological feature have been previously registered.

13. The method of claim 1, further comprising:
analyzing the digital image sequence to determine that the at least one trait of the identified dermatological feature can be estimated with an image impairment better than a threshold;
wherein the estimating the at least one trait of the identified dermatological feature using the imaging reference and at least one image of the digital image sequence is executed if the image impairment is better than the threshold; and
registering the digital image sequence.

14. The method of claim 1, further comprising determining if a quality of at least one image of the digital image sequence is less than the threshold, and providing corrective measures for recapturing the at least one image of the digital image sequence of the dermatological feature and the imaging reference based on analysis of components of the quality of the at least one image of the digital image sequence.

15. The method of claim 13, further comprising dynamically adjusting the threshold based on at least one of characteristics of identified dermatological feature and previously acquired digital image sequences.

16. The method of claim 13, wherein registering the digital image sequence along with time stamps further comprising:
adding the digital image sequence to a series, wherein the series contains a plurality of previously acquired and stored digital image sequences representing a same identified dermatological feature, or if no series exists, starting a new series using this digital image sequence as a base sequence;
analyzing the digital image sequence and one or a plurality of stored series to match the digital image sequence based on an imaged dermatological feature into a existing series representing this imaged dermatological feature;
correcting user classification of a the digital image sequence if there is an insufficient match of dermatological feature to series to which user assigned sequence.

17. The method of claim 1, wherein estimating at least one trait of the identified dermatological feature using the imaging reference includes at least one of a geometric area, geometric size, geometric depth, geometric length, geometric volume, spectral color, or spectral intensity.

18. The method of claim 17, wherein the identified dermatological feature represents a spatial region where features being estimated within the spatial region comprise multiple spatial elements.

19. The method of claim 4, wherein comparatively analyzing the digital image sequence with at least one previously acquired digital image sequence to identify relative differences comprises:
calibrating geometric or spectral traits using the imaging reference in the digital image sequence and a previously stored series of image sequences, and determining if calibration is required beyond a first threshold;
correlating the calibrated image sequence with the previously stored series of image sequences, and determining if correlation is beyond a second threshold;
selecting images from the digital image sequence if calibration required is less than the first threshold and correlation required is greater than the second threshold.

20. The method of claim 3, further comprising analyzing a series of digital image sequences, wherein the analyzing comprises characterizing evolution over the series of digital image sequences of an estimated trait or plurality of traits of a dermatological feature or plurality of dermatological features.

21. The method of claim 20, wherein characterizing evolution over the series of digital image sequences of an estimated trait or plurality of traits of a dermatological feature or plurality of dermatological features comprises:
applying a scale independent feature detection algorithm to at least one image of at least one sequence of the series of digital image sequences to produce a first output image;
applying a first series of image morphology operations to the first output image to produce a second output image;
generating a first bit map representing pixels containing the dermatological feature or plurality of dermatological features
applying a second series of image morphology operations to the first output image to produce a third output image;
generating a second bit-map representing pixels not containing the dermatological feature or plurality of dermatological features, based on the third output image;
combining the first and second bit-maps with one or a plurality of the images of the series of digital image sequences to create a first set of feature containing pixels and second set of non-feature containing pixels;
characterizing evolution over the series of digital image sequences of an estimated trait or plurality of traits using the first and second set of pixels.

22. The method of claim 21, where combining the first and second bit-maps with one or a plurality of the images of the series of digital image sequences to create a first set of feature containing pixels and second set of non-feature containing pixels comprises,
calibrating the one or a plurality of images of the series of digital image sequences to geometrically map the dermatological features to the corresponding locations of the first bit map,
applying the first and second bit-map to one or a plurality of the calibrated images of the series of digital image sequences to create a first set of feature containing pixels and second set of non-feature containing pixels.

23. The method of claim 1, further comprising:
prompting a user to reinitiate obtaining a digital image sequence of the identified dermatological feature, wherein the prompting is based on an amount of time since last obtaining of a digital image sequence.

24. The method of claim 1, where the digital image sequences are stored on a central server, wherein the server is remotely accessible.

25. The method of claim 1, wherein the identified dermatological feature is a lesion.

26. The method of claim 25, wherein color spectral distribution on imaging reference is chosen based on color spectral distribution of skin on which lesion is present.

27. The method of claim 25, further comprising electronically sending a change report to a dermatologist to document, enabling treatment and insurance process.

28. The method of claim 5, in which the marker is an ink or other drawn, printed or stamped marker on the surface encompassing the dermatological feature.

29. The method of claim 1, further comprising:
analyzing the digital image sequence to determine that the imaging reference can be estimated with fidelity greater than a threshold,
if the fidelity is greater than the threshold, then estimating the at least one trait of the identified dermatological feature using the imaging reference and at least one image of the digital image sequence; and
registering the digital image sequence.

30. A spatial target tracking device, comprising:
means for establishing an imaging reference proximate to an identified spatial target;
means for obtaining a digital image sequence of the spatial target and imaging reference;
means for analyzing the digital image sequence and imaging reference to determine that a quality of the digital image sequence is greater than a threshold; if the quality is greater than the threshold, then means for estimating at least one feature of the spatial target using the imaging reference, and cataloging the digital image sequence along with a time stamp.

31. A computing device, comprising:
a controller,
electronic memory operable to receive a downloadable dermatological tracking program;
wherein the controller is operable according to the downloadable dermatological tracking program to cause the computing device to perform the following steps:
obtain a digital image sequence, containing one or more images, of an identified dermatological feature and an imaging reference;
establishing the imaging reference proximate to the identified dermatological feature in the digital image sequence, wherein the imaging reference has a known color spectrum and known physical dimensions;
estimating at least one trait of the identified dermatological feature using the imaging reference and at least one image of the digital image sequence.

32. A method for tracking a spatial target, comprising:
establishing an imaging reference proximate to an identified dermatological feature, wherein the imaging reference has a constant color spectrum and constant physical dimensions;
obtaining a digital image sequence, containing one or more images, of the identified dermatological feature and the imaging reference;
estimating at least one trait of the identified dermatological feature using the imaging reference and at least one image of the digital image sequence.

33. The method of claim 32, further comprising
obtaining the digital image sequence with corresponding time stamps during a time interval less than a first threshold, wherein identified dermatological feature evolves in time greater than a second threshold, and wherein the first threshold is less than the second threshold;
acquiring at least one of a series of the digital image sequences, wherein a second time interval between acquisition of each digital image sequence of each series is greater than the second threshold;
organizing the at least one of a series of digital image sequences along with corresponding time stamps by assembling the series in a catalog, wherein each series represents time evolution of at least one trait of the identified dermatological feature or a plurality of dermatological features.
